(19) United States
(12) Patent Application Publication
(10) Pub. No.: US 2014/0202979 A1
(43) Pub. Date: Jul. 24, 2014

(54) APPARATUS FOR STORAGE AND SAMPLING OF DE-IONIZED WATER SAMPLES AND THE LIKE

(71) Applicant: GENERAL ELECTRIC COMPANY, Schenectady, NY (US)

(72) Inventor: Paul Peter Kosenka, Denver, CO (US)

(73) Assignee: GENERAL ELECTRIC COMPANY, Schenectady, NY (US)

(21) Appl. No.: 13/746,426

(22) Filed: Jan. 22, 2013

(51) Int. Cl. A61J 1/14; B65D 81/26

(52) U.S. Cl. CPC A61J 1/1406; B65D 81/266
USPC 215/247; 206/205

(57) ABSTRACT

A container is provided for the storage and sampling of aqueous samples, such as deionized water samples. The container comprises an enclosure with an open mouth portion that is sealed via a needle penetratable septa. The septa overlies the mouth and seals the enclosure from the outside atmosphere. The septa comprises a foil layer adjacent the mouth that provides a border between the enclosure and the outside atmosphere and a Teflon layer adjacent the sample. A silicone containing layer of the septa is provided intermediate the foil layer and Teflon layer. A cap member may be provided that is detachably and sealingly engaged to the container covering the mouth. A CO₂ adsorbent material may be provided in the space existing between the mouth of the enclosure and a cap member.

### FIELD OF INVENTION

The invention pertains to a sealed container adapted to store water samples and facilitate testing of the sample such as for conductivity, total organic carbon or other analytical testing procedures.

### BACKGROUND OF THE INVENTION

Currently, in the pharmaceutical industry, the conductivity of the water used for manufacturing as well as water for injection must be measured. The United States Pharmacopeia permits three different methods to determine if the water meets specification. Each of these methods or stages as they are referred to have specific limits and require increasingly more difficult measurements. The three levels of measurement attempt to set a limit on ionic contamination of the water excluding the conductivity associated with the dissolution of carbon dioxide and ammonia gasses.

Briefly, Stage 1 requires the measurement of conductivity and temperature. A table is provided to determine if the water has met specification. For example, the conductivity limit for a temperature of 25° C. is 1.3 μS/cm. If the conductivity exceeds any of the values at a given temperature one is instructed to perform Stage 2 measurements. This requires the sample to be maintained at temperature of 25° C. and then vigorously agitated to equilibrate with atmospheric carbon dioxide. Stage 2 testing requires the sample water to be set to a specific temperature and allowed to equilibrate with the CO₂ in the atmosphere. The limit set for Stage 2 conductivity is 2.1 μS/cm. If the sample exceeds the specification of Stage 2, then Stage 3 measurements need to be made. The pH of the sample is measured and must be between pH 5 and pH 7. The pH of the sample is then used to look up the specified conductivity at that pH.

Clearly being able to make Stage 1 measurements is desirable from the standpoint of simplicity. However, taking and storing the sample for later analysis has proven to be problematic. When de-ionized water or nearly de-ionized, water is stored in a container for subsequent conductivity measurement, the sample must be protected from contamination both from the container and also from permeation of CO₂ into the container from the atmosphere. If this is not done, then it is unlikely the sample will pass the Stage 1 specifications.

Containers for sampling water for later analysis have been fabricated out of glass or plastic, depending on the particular analysis that would be undertaken. Conventionally, used glass bottles often contaminate the sample via leaching of various ionic species into the sample. For instance, in many cases, alkali metals can leach into the sample from the surrounding glass, but other metals such as iron leaching can also prove detrimental.

In some instances, plastic containers have been employed. Although most plastic bottles can be treated to remove ionic contamination, almost all plastics are to some extent gas permeable. As CO₂ from the atmosphere permeates through the plastic, it will form carbonic acid and change the conductivity of the sample.

### SUMMARY OF THE INVENTION

In one embodiment, the invention is directed toward an apparatus for storing and sampling of deionized water samples. The apparatus comprises a container defining an enclosure with a bottom and an opposing open mouthed top end and container walls connecting the bottom and the top to define the enclosure. A needle penetratable septa overlies the open mouth top to seal the enclosure from the outside atmosphere. The septa comprises a foil layer adjacent the mouth that provides a border between the enclosure and the outside atmosphere. A Teflon layer is adjacent the mouth and is located proximate or in contiguous relation with the water sample in the container. A silicone containing layer of the septa is provided, and this layer is located intermediate the foil layer and the Teflon layer.

In another embodiment, a cap member is provided that detachably and sealingly engages with the container covering the mouth of the container. In another aspect of the invention, a space is provided between the mouth and the interior of the cap member. A CO₂ adsorbent may be disposed in this space, overlying the septa. The CO₂ adsorbent may, for example, be provided in an air permeable package or the like or, in certain instances, it could be provided in a netting or other similar air permeable medium. The CO₂ adsorbent may comprise a molecular sieve material, such as a zeolite, or soda lime.

In another embodiment of the invention, the foil layer of the septa comprises an aluminum foil having a thickness of about 0.5-1 millimeter. The silicone layer of the septa may for example have a thickness of about 1-3 millimeters, and the Teflon layer, in contact with the aqueous sample disposed in the container, may have a thickness of about 0.5-2 millimeters.

In certain preferred embodiments of the invention, the container may comprise a glass container having a layer of SiO₂, i.e., quartz, on the inside surface thereof, adapted to contact the deionized water sample. This layer inhibits leaching of metallic ions from the glass into the sample.

### BRIEF DESCRIPTION OF THE DRAWINGS

The invention will be described in conjunction with the following drawings, wherein:

FIG. 1 is a schematic side sectional view of a container and a cap combination in accordance with one embodiment of the invention;

FIG. 2 is a schematic side sectional view of the combination of FIG. 1 with the CO₂ adsorbent packet removed from the space in the cap to show the positioning of the septa covering the mouth of the container;

FIG. 3 is a partially cut-away side section of one exemplary container; and

FIG. 3A is a schematic cross sectional view of one embodiment of a septa in accordance with the invention.

### DETAILED DESCRIPTION OF EXEMPLARY EMBODIMENTS

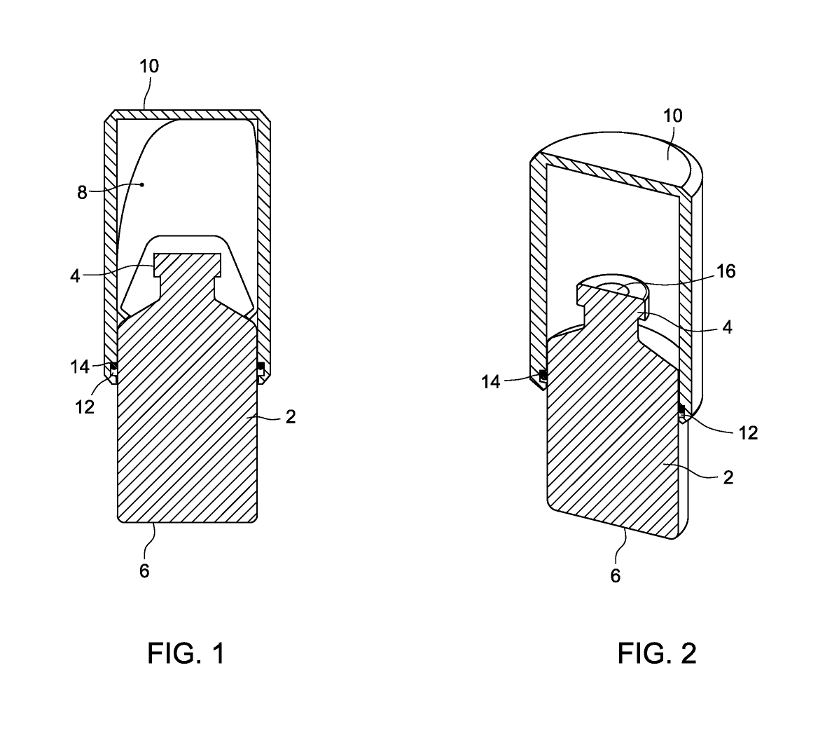

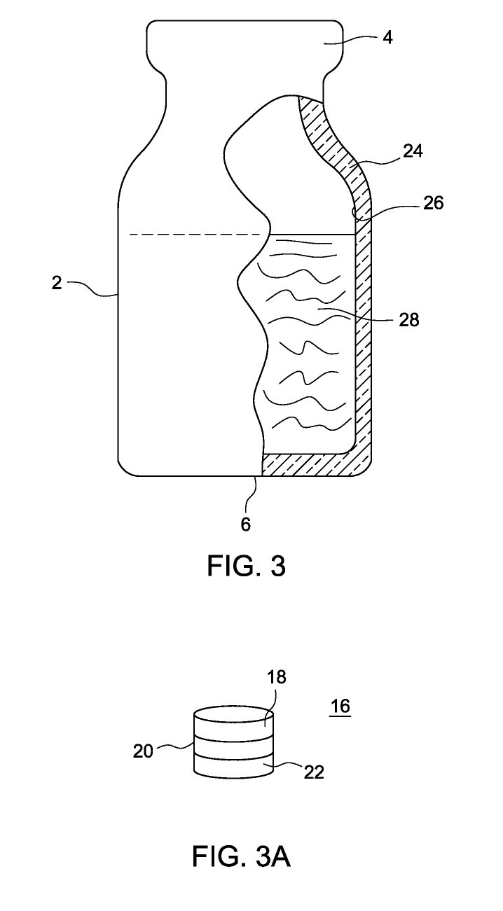

Turning to FIG. 1, there is shown a container 2 having a top open mouth portion 4 and opposing bottom end 6. As shown, the container comprises generally cylindrical walls 24 (FIG. 3) that define an enclosure along with the top and bottom. A CO₂ adsorbent containing packet 8 is positioned over the container mouth within the space defined between the top of the container and cap 10 that is detachably, but sealingly, engaged to the container.

As shown, cap 10 is connected to container 2 via an annular groove 12 formed in the bottom of the cap that mounts an o-ring 14 therein. In this embodiment, the cap may be compressed at about its mid-length portion to resiliently expand the bottom section thereof so that the cap can be disengaged with the container. The artisan will appreciate that a variety of other engagement arrangements such as threaded, snap fit, bayonet, or detent like configurations could also be provided.

FIG. 2 shows the disposition of sealing septa 16 over the mouth of the container. The septa should sealingly close the mouth and is penetrable by a sharp needle or the like so as to facilitate removal of a sample of the DI water stored within the container for conductivity, TOC, or other analysis. As shown in FIG. 3A, in one embodiment, the septa comprises a top layer of metallic foil 18 such as Al or the like, with a bottom Teflon layer 22 for placement adjacent the liquid sample within the container. A silicone layer 20 is disposed between the layers 18 and 22 to provide pliability to the septa. The foil layer helps to prevent CO₂ permeation through the closure.

Turning now to FIG. 3, there is shown another embodiment wherein the container is composed of glass that has been provided with a quartz SiO₂ coating 26 all along the inside of the container walls 24 in contact with the aqueous sample 28. Containers of the type shown in this embodiment are described in U.S. Pat. No. 6,599,594, incorporated by reference herein. The SiO₂ quartz lining helps to prevent the leaching of ionic constituents that may be present in the glass composition into the aqueous sample 28.

Turning back again to FIG. 1, it should be noted that the CO₂ adsorbent material 8 depicted in that figure as being encapsulated in an air permeable packet can be provided in a mesh or in some instances in a film that could cover the mouth of the container overlying the septa 16. A variety of different types of CO₂ adsorbents may also be employed, for example, molecular sieves, such as the zeolites, silica gels, soda lime, etc., may also be mentioned.

### EXAMPLES

Various container samples were used to store DI water samples followed by conductivity measurements after five days storage. Conductivity results are shown in the Table.

| Sample I.D. | Conductivity |
|---|---|
| control - at filling | mean 0.098 μS/cm = +/−0.14 |
| C-1 | mean 0.350 μS/cm = +/−0.03 |
| | 0.50 (μ/S cm)/day |
| Ex 1 | mean 0.214 μS/cm = +/−0.016 |
| | 0.023 (μ/S cm)/day |
| Ex 2 | mean 0.180 μ/S cm +/− 0.03 |
| | 0.016 (μ/S cm)/day |

C-1 Schott Type 1 plus ® borosilicate glass container; SiO₂ inner lining (hereinafter SBS glass); with silicone/Teflon septa
Ex-1 SBS glass, Al foil/silicone/Teflon septa
Ex-2 SBS glass, Al foil/silicone/Teflon septa, secondary cap 10 and CO₂ adsorbent packet 8.

It is accordingly clear that the present invention uses, in one embodiment, an SiO₂ coated glass vial to store the sample. In other embodiments, a multi-layer septa consisting of a Teflon layer that is in contact with the sample, a silicone layer that provides pliability, and a foil layer to prevent the permeation of CO₂ through the closure are employed. An additional item offering protection from CO₂ intrusion is a cap member that makes a seal on the outside of the glass vial. Inside this secondary cap, a CO₂ adsorbing material is provided.

In accordance with preferred embodiments, the container has an inside surface with low leachable ionic material and is not permeable to carbon dioxide. There are processes that coat glass surfaces with a thin film of silicon dioxide. This coating prevents metal ions in the glass from leaching into the sample. One example of such a glass via is sold commercially under the mark Schott Type 1+. The primary closure with metal foil component of the septa presents a barrier to the permeation of CO₂ in the sample material. The cap with a CO₂ adsorber therein protects the sample when the primary enclosure is imperfect and prevents permeation through the sides of the septa seal.

The container in accordance with the invention is well-suited to store deionized water samples prior to analysis of the sample under the Stage 1 conductivity testing protocol thus avoiding the complications of Stage 2 or Stage 3 measurements. Stage 2 testing protocol mandates accurate temperature control before the conductivity is measured. There is also a provision in the protocol to the effect that the sample has to come to equilibrium with atmospheric carbon dioxide before the conductivity is measured. This testing is complicated and time consuming Being able to take a sample and simply measure the conductivity greatly reduces the analysis time for the customer. An added advantage is that when sampling pharmaceutical water, two samples are taken, one for the conductivity and the other for measurement of total organic carbon (TOC). The sampling container in accordance with the invention makes possible the measurement of conductivity and TOC with one sample. This greatly reduces the amount of analysis time for the customer.

1. Apparatus for storage and sampling of de-ionized water samples, said apparatus comprising:
a container defining an enclosure with a bottom, an opposing open mouthed top end and container walls connecting said bottom and top to define said enclosure,
a needle penetrable septa overlying said open mouthed top to seal said enclosure from the outside atmosphere, said septa comprising a foil layer adjacent said mouth and providing a border between said enclosure and said outside atmosphere, a Teflon layer adjacent said mouth and a silicone containing layer intermediate said foil layer and said Teflon layer.

2. Apparatus as recited in claim 1 further comprising a cap member detachably and sealingly engaged to said container and covering said mouth.

3. Apparatus as recited in claim 2 wherein a space is provided between said mouth and said cap member wherein a CO₂ adsorbent material is disposed in said space, overlying said septa.

4. Apparatus as recited in claim 3 wherein said CO₂ adsorbent is provided in an air permeable package.

5. Apparatus as recited in claim 4 wherein said CO₂ adsorbent comprises a molecular sieve material or soda lime.

6. Apparatus as recited in claim 1 wherein said foil layer comprises Al foil having a thickness of about 0.5-1 mm

7. Apparatus as recited in claim 1 wherein said silicone layer has a thickness of about 1-3 mm.

8. Apparatus as recited in claim 1 wherein said Teflon layer has a thickness of about 0.5-2 mm

9. Apparatus as recited in claim 1 wherein said container is a glass container having a layer of SiO₂ disposed on an inside surface thereof adapted to contact said de-ionized water sample while inhibiting leaching of metallic ions from said glass into said sample.
